(19) United States
(12) Patent Application Publication
(10) Pub. No.: US 2005/0126607 A1
(43) Pub. Date: Jun. 16, 2005

(54) Dishwasher liquid delivery system

(76) Inventors: Thomas Haft, Coloma, MI (US); David M. Romig, Dowagiac, MI (US); Jeff M. Borah, St. Joseph, MI (US)

Correspondence Address: WHIRLPOOL PATENTS COMPANY - MD 0750, 500 RENAISSANCE DRIVE - SUITE 102, ST. JOSEPH, MI, 49085, US

(21) Appl. No.: 10/734,332

(22) Filed: Dec. 13, 2003

(51) Int. Cl. B08B 3/02

(52) U.S. Cl. 134/56 D; 134/93; 134/94.1; 134/95.1; 134/98.1; 134/200

(57) ABSTRACT

The invention relates to a household dishwasher having a liquid delivery system for transporting liquid from an external supply or a dishwasher wash chamber to a liquid-using washing accessory preferably located on the inner face of the dishwasher door.

### BACKGROUND OF THE INVENTION

1. Field of the Invention

The invention relates to a liquid delivery system for a dishwasher and more particularly to a dishwasher liquid delivery system for supplying liquid to an accessory mounted to the dishwasher door.

2. Description of the Related Art

Household dishwashing machines are equipped with various types of wash aid dispensers. The inside surface of the dishwasher door is the preferred location for a dispenser because the area is easily accessible to a user when the door is opened. A typical dispenser comprises a recess for receiving a wash aid, such as a detergent, rinse aid, a film remover, and the like, covered by a hinged lid. Prior to use, the user fills the recess with the desired wash aid(s) and secures the cover in a closed position to contain the wash aid in the recess. During the dishwashing cycle, the dispenser cover is released to an open position, thereby permitting the liquid in the wash chamber to access the recess and incorporate the wash aid into the liquid that recirculates throughout the interior of the wash chamber to clean and rinse the ware objects located therein.

While these types of wash aid dispensers are useful for their intended purpose, they do have functional limitations. For example, these dispensers are dependent on the recirculating wash water to flush out the wash aid from the dispenser. The recirculation of the wash water is typically accomplished by two rotating spray arms, one located in the bottom of the dishwasher above a recirculation pump and below a lower dish basket, and another located in an upper portion of the dishwasher usually immediately below an upper dish basket. Depending on how the user loads dishes into the upper and lower baskets, the recirculating wash liquid emanating from the spray arms may be blocked by the dishes from directly contacting the open dispenser, which reduces the efficacy of the recirculation system in flushing out the wash aid. This is especially true for dry or powder detergents that do not readily flow out of the dispenser like liquid wash aids. Under certain conditions, it is possible for a dry or powder detergent to cake within the dispenser and not dispense.

A further disadvantage is that the above-described dispensers are not well suited for use in bulk wash aid dispensers, an example of which is disclosed in Applicant's concurrently filed United States patent application, entitled “Dishwasher with Bulk Wash Aid Dispenser”, which is incorporated by reference in its entirety, and is filed concurrently herewith. Bulk wash aids, which are an agglomeration of multiple charges of a wash aid are desirable because the user does not have to replace the wash aid between each use of the dishwasher nor determine the quantity of wash aid in the dishwasher liquid solution. However, proper metering of the bulk wash aid must be ascertained since the dishwasher will no longer rely on the user metering the proper amount of wash aid as part of the wash aid loading step. Similarly, the user cannot be relied upon to to make sure that the prior wash aid was completely dispensed and did not cake, for example.

### SUMMARY OF THE INVENTION

The invention addresses the shortcomings of prior dishwashers by providing liquid directly to the door of the dishwasher for use by a wash aid dispenser or other liquid using accessory. In one aspect, the invention relates to a household dishwasher comprising a housing defining wash chamber in which dishes can be stored for washing and the wash chamber having a peripheral edge defining an open face providing access to the wash chamber. The dishwasher has a door having an inner face and movably mounted to the housing for movement between a closed position, where the door is adjacent the peripheral edge to close the open face to block access to the wash chamber, and an opened position, where the door is remote from the open face to permit access to the wash chamber. The dishwasher further comprises a liquid sprayer for spraying liquid into the wash chamber and comprising a pump and a spray arm fluidly connected to the pump such that the pump supplies liquid to the spray arm for spraying about the wash chamber; a liquid-using washing accessory provided on the inner face of the door; and a liquid delivery system for delivering liquid from at least one of an external supply and the wash chamber to the liquid-using washing accessory.

The liquid delivery system includes a liquid conduit comprising a first hose portion carried by the housing and fluidly coupled to one of the external supply and the wash chamber, a second hose portion carried by the door and fluidly coupled to the liquid-using washing accessory, and a transition portion fluidly coupling the first and second portions at an interface between the wash chamber and the door at least when the door is closed. The second hose portion can be located within the interior of the door.

The transition portion is a third hose portion fluidly connecting the first and second hose portions. The transition portion can alternatively comprise a fluid coupling that fluidly couples the first and second hose portions when the door is in the closed position. The fluid coupling can comprise a valve to prevent the flow of water from the first hose portion to the second hose portion when the door is in the opened position and a seal to fluidly seal the first and second hose portions when the door is in the closed position.

The first, second, and third hose portions can be integrally formed to define a one-piece liquid conduit, and the one-piece liquid conduit can comprise multiple discrete fluid passages to provide multiple discrete sources of liquid to the liquid-using washing accessory.

At least one of the first, second, and third hose portions is extendable to accommodate any changes in the hose length needed to move the door between the opened and closed positions.

The door can be hingedly mounted to the housing for rotation about a hinge axis, wherein the third hose portion extends between the first and second hose portions at the portion of the interface coinciding with the hinge axis. Furthermore, the door can be hingedly mounted to the housing at a lower portion of the housing and the hinge axis is generally horizontal so that the door will pivot between a generally vertical position when the door is in the closed position and a generally horizontal position when the door is open.

The liquid delivery system can further comprise a selectively-actuable, multiple outlet valve having one inlet connected to the external supply, one outlet connected to the wash chamber, and another outlet connected to the first hose portion to selectively control the supply of liquid from the external supply to either the wash chamber or first hose portion. The liquid delivery system can also comprise a selectively-actuable, multiple outlet valve having an inlet connected to the one of the external supply and the wash chamber, one outlet fluidly coupling one of the multiple passageways, and another outlet fluidly coupling another of the multiple passageways to selectively control the supply of liquid to the multiple passageways.

The liquid-using wash accessory can be a bulk wash aid dispenser.

In another aspect, the invention relates to a household dishwasher comprising a housing defining wash chamber in which dishes can be stored for washing and the wash chamber having a peripheral edge defining an open face providing access to the wash chamber. The dishwasher has a door having an inner face and movably mounted to the housing for movement between a closed position, where the door is adjacent the peripheral edge to close the open face to block access to the wash chamber, and an opened position, where the door is remote from the open face to permit access to the wash chamber. The dishwasher further comprises a liquid sprayer for spraying liquid into the wash chamber and comprising a pump and a spray arm fluidly connected to the pump such that the pump supplies liquid to the spray arm for spraying about the wash chamber; a bulk wash aid dispenser provided on the inner face of the door; and a liquid delivery system for delivering liquid from at least one of an external supply and the wash chamber to the bulk wash aid dispenser.

The liquid delivery system includes a liquid conduit comprising a first hose portion carried by the housing and fluidly coupled to one of the external supply and the wash chamber, a second hose portion carried by the door and fluidly coupled to the liquid-using washing accessory, and a third hose portion fluidly coupling the first and second portions at an interface between the wash chamber and the door at least when the door is closed, wherein the first, second, and third hose portions can be integrally formed to define a one-piece liquid conduit.

### BRIEF DESCRIPTION OF THE DRAWINGS

In the drawings:

FIG. 1. is a perspective view of a dishwasher with a door in an open position and having a liquid delivery system according to the invention.

FIG. 2 is bottom plan view of the dishwasher in FIG. 1 with an outer surface of the door removed.

FIG. 3 is a perspective view of a dishwasher with a door in the open position and having a second embodiment of a liquid delivery system according to the invention.

FIG. 4 is a partial perspective view of the dishwasher in FIG. 5 showing a liquid conduit for the liquid delivery system rail functioning also as a rail for supporting a dish basket.

FIG. 5 is a perspective view of a dishwasher with a door in the open position and having a third embodiment of a liquid delivery system according to the invention.

### DESCRIPTION OF THE INVENTION

The invention relates to a dishwasher with a liquid delivery system that transports liquid from a supply to an accessory, such as a bulk wash aid dispenser, spray nozzle, and the like, positioned on the inside of the dishwasher door.

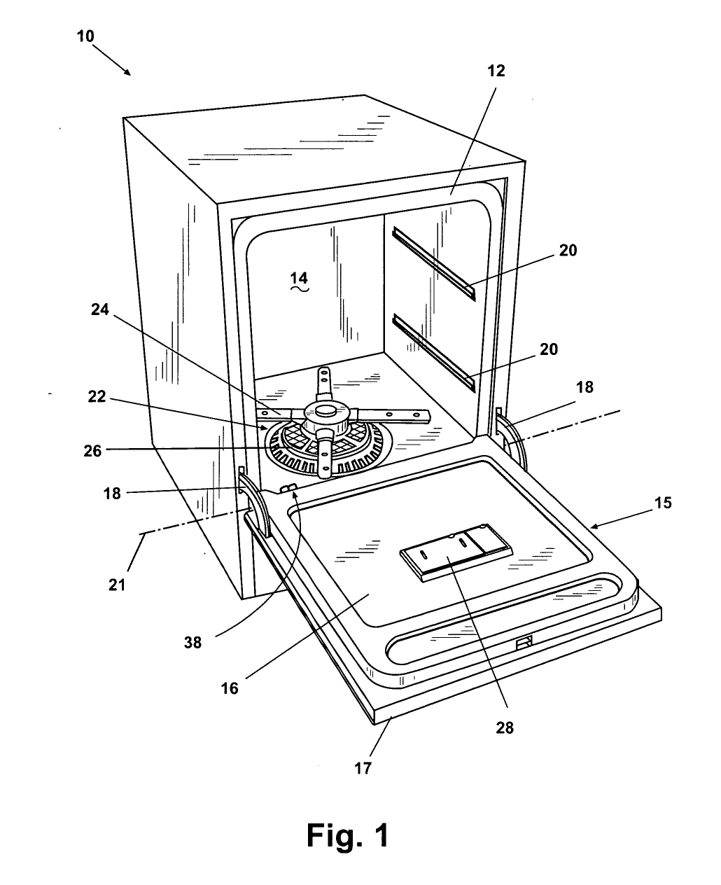

Referring now to the figures and FIG. 1 in particular, a dishwasher 10 incorporating the invention comprises a housing 12 defining a wash chamber 14 with an open face. A door 15 with an inner face 16 and an outer face 17 is mounted, preferably at its lower end, to the housing 12 via hinges 18 and is movable about a generally horizontal hinge axis 21 between a closed position and an open position. In the closed position, the door 15 is substantially vertical, and its inner face 16 closes the open face of the wash chamber 14, thus preventing access to the wash chamber 14 and sealing the wash chamber 14 to prevent the escape of liquid during the wash cycle. In the open position, as shown in the figures, the door 15 is away from the open face to permit access to the wash chamber 14 and is substantially horizontal relative to the floor when in a fully opened position.

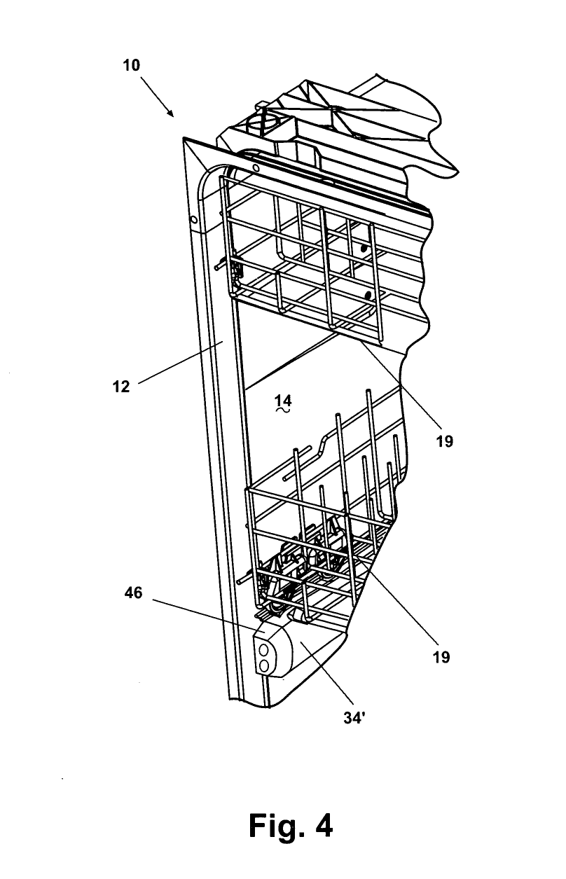

Additionally, the dishwasher 10 preferably comprises at least one dish basket 18, shown in FIG. 4, for storing table ware, pots and pans, utensils, and other equipment within the wash chamber 14. The at least one dish basket 19 is supported by and slidably mounted to parallel rails 20. The lower rails 20 preferably align with the inner surface 16 of the door 15 when the door 15 is in the opened position to permit the basket 19 to be rolled from the rails 20 in the wash chamber 14 and onto the inner surface 16 of the door 15 to move the basket between a stored position within the wash chamber 14 to a load/unload postion on the door 15.

The household dishwasher 10 further comprises a liquid sprayer 22 for introducing, recirculating, and spraying liquid throughout the wash chamber 14. The liquid sprayer is well known and includes components such as a spray arm 24 and a recirculating pump 26. The pump 26 takes water introduced into wash chamber 14 from an external water supply and pumps it to the spray arm 24, which directs the water throughout the wash chamber 14, where it falls back toward the pump 26. The water is then recirculated. The liquid sprayer 22 illustrated in the figures is exemplary, and other types of liquid sprayers with components positioned in different locations or alternative components can be utilized in conjunction with the present invention. The features of liquid sprayers are well known and are not germane to the invention; therefore, the liquid sprayers are well know and will not be described in further detail.

A liquid-using washing accessory, such as a bulk wash aid dispenser 28 for metering multiple single charges of wash aid from one or more bulk wash aid supplies is shown mounted to the inner face 16 of the door 15. An example of a suitable bulk wash aid dispenser is shown in Applicant's above-identifed application. However, any appropriate bulk wash aid dispenser or any liquid-using washing accessory can be mounted to the door 15. It is only necessary that the accessory is sized to fit on the inner face 16 of the door 15 and employs liquid to perform its intended function. The type of liquid-using washing accessory is not limiting to the invention. Other liquid-using accessories disposed on the inner face 16 of the dishwasher door 15 could include a spray nozzle for spraying liquid into the wash chamber 14, especially a focused spray on a pre-selected location, such as, for example, a silverware basket, or other non-bulk wash aid dispenser.

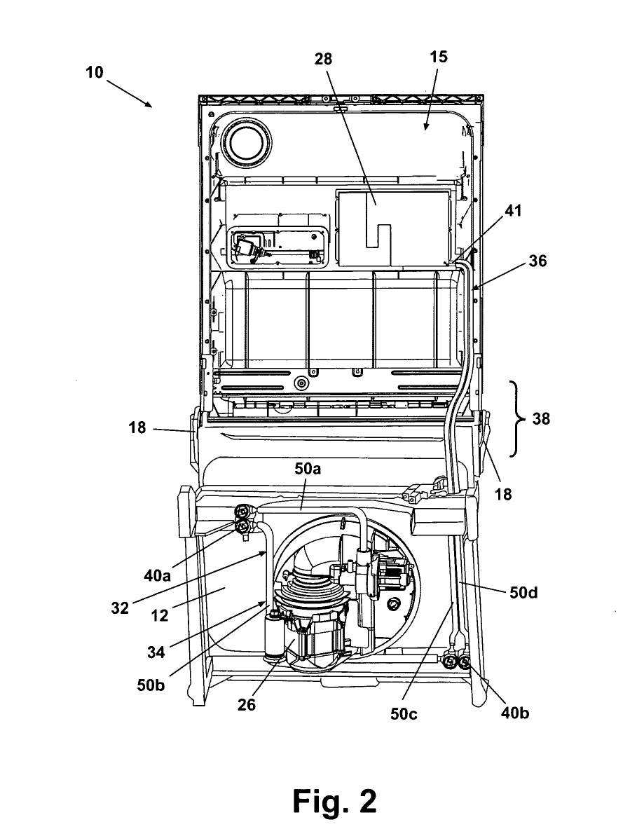

As depicted in FIGS. 1 and 2, the dishwasher 10 is equipped with a liquid delivery system 30 for transporting liquid to the bulk wash aid dispenser 28. The liquid delivery system 30 comprises a liquid conduit 32 that fluidly connects the bulk wash aid dispenser 28 to an external supply (not shown). The liquid conduit 32 can conceptually divided into three portions. A first portion for carrying the liquid from the supply through the housing, a second portion for carrying the liquid from through the door to the liquid-using accessory, and a transition portion that transfers the fluid from the first and second portions or, in other words, across the interface between the housing and the door. As illustrated in FIG. 2, the first portion is a first hose portion 34 carried by the housing 12 and preferably by the undersurface of the housing 12. Similarly, the second portion comprises a second hose portion 36 that is carried by the door 15 and fluidly coupled with the bulk wash aid dispenser 28. It is preferred that the second hose portion 36 is disposed in the interior of the door 15 between the inner face 16 and the outer face 17 such that the second hose portion 36 is sufficiently concealed for an aesthetic appearance.

The transition portion comprises a third hose portion 38 that fluidly couples the first and second hose portions 34, 36 at an interface between the housing 12 and the door 15. The interface can be located in any region around the peripheries of the housing 12 and the door 15 where the housing 12 and the door 15 meet when the door 15 is in the closed position. Preferably, the third hose portion 38 is disposed at the portion of the interface where the hinge axis 21 is located as this will reduce any need for the third hose portion 38 to extend or contract as the the door 15 is open and closed and minimize interferance with access by the user. As illustrated, the hinge axis 21 is at the lower end of the door 15. However, the hinge axis 21 could be located elsewhere on the housing/door interface, although for many reasons it is not traditional to do so. Furthermore, at least the third hose portion 38 is preferably composed of an extendable material that can easily change length when the door 15 is moved about the hinge axis 21 between the opened and closed positions. The first and second hose portions 34, 36 can be made of extendable material if needed.

Preferably, the first, second, and third hose portions 34, 36, 38 form an integral one-piece liquid conduit that is carried by the housing 12 and the door 15 and that fluidly connects the external supply to the bulk wash aid dispenser 28. Additionally, the liquid conduit 32, whether comprised of non-integral individual hose sections 34, 36, 38 or the one-piece liquid conduit, can be a single hose with a single fluid passage, a single hose with multiple parallel and discrete fluid passages, or multiple parallel hoses with each having a solitary fluid passage. If the liquid conduit is comprised of non-integral individual hose sections 34, 36, 38, each hose section can have its own type of hose, or two or more hose sections can share the same variety of hose.

The liquid delivery system 30 can further comprise one or more valves 40 disposed at various locations along the liquid conduit 32 to control the flow of liquid from the external supply to the bulk wash aid dispenser 28. The valves 40 can be selectively and individually actuated via a control circuit (not shown) to regulate the flow of liquid to the multiple hoses and/or multiple passageways of single hoses. Furthermore, the valves 40 can have any number of inlets and any number of outlets to accommodate the various types of hoses, liquid-using washing accessories, and sources of liquid in the liquid delivery system 30. In the embodiment shown in FIG. 2, for example, the liquid delivery system 30 has a one inlet-two outlet valve 40a, wherein the one inlet is connected to the external supply and the two outlets are coupled with hose section 50a that connects to the wash chamber 14 and hose section 50b that connects to a second one inlet-two outlet valve 40b. The second valve 40b is coupled with a one-piece liquid conduit having multiple parallel hose sections 50c, 50d that connect to inlets 41 leading to multiple bulk wash aid receptacles for housing different types of bulk wash aids in the bulk wash aid dispenser 28.

In this configuration, the first hose portion 34 comprises a portion of the valve 40a, hose section 50b, valve 40b, and a portion of the hose sections 50c, 50d. The second hose portion 36 comprises the distal portion of the hose sections 50c, 50d. The transition portion or third hose portion 38 comprises the intermediate portion of the hose sections 50c, 50d.

The operation of the liquid delivery system 30 will now be described with respect to the example shown in FIGS. 1 and 2. At the beginning of a typical dishwashing cycle, the door 15 is in the closed position, and the wash chamber 14 is filled with liquid from the external supply. At various stages in the cycle, the pump 26 transports the liquid to the at least one spray arm 24 to circulate the liquid throughout the wash chamber 14. When the cycle requires the addition of a charge of wash aid from the bulk wash aid supply, valve 40a opens, and liquid from the external supply flows along the first hose portion 34 of the liquid conduit 32 to valve 40b. The valve 40b directs the liquid flow to the appropriate passageway, depending on which bulk wash aid is required, on the outlet side of the valve 40b. The flow of liquid continues along the appropriate passageway of the first hose portion 34 on the underside of the housing 12, through the third hose portion 38 at the interface between the housing 12 and the door 15, and along the second hose portion 36 in the door 15. The liquid ultimately reaches the selected liquid-using washing accessory, in this case a bulk wash aid dispenser 28, which meters an individual charge of wash aid and dispenses it into the wash chamber 14 for use in the dishwashing cycle. Delivery of liquid to the liquid-using washing accessory can occur as often as necessary throughout the cycle and, in the case where the liquid-using washing accessory is a bulk wash aid dispenser 28, to as many bulk wash aid receptacles as necessary, either individually or at the same time.

While the embodiment of FIGS. 1 and 2 is shown carrying liquid from an external supply to the door, the invention can be used to connect other liquid supplied to the door. For example, the liquid conduit 32 can be fluidly coupled between the dispenser 28 and the wash chamber 14 to send wash liquid to the dispenser. While the above description details the liquid delivery system 30 as having the external supply as the source of liquid, the invention shall not be limited in this manner. Either the external supply, the wash chamber 14, or both can serve as a source of liquid for the liquid-using washing accessory.

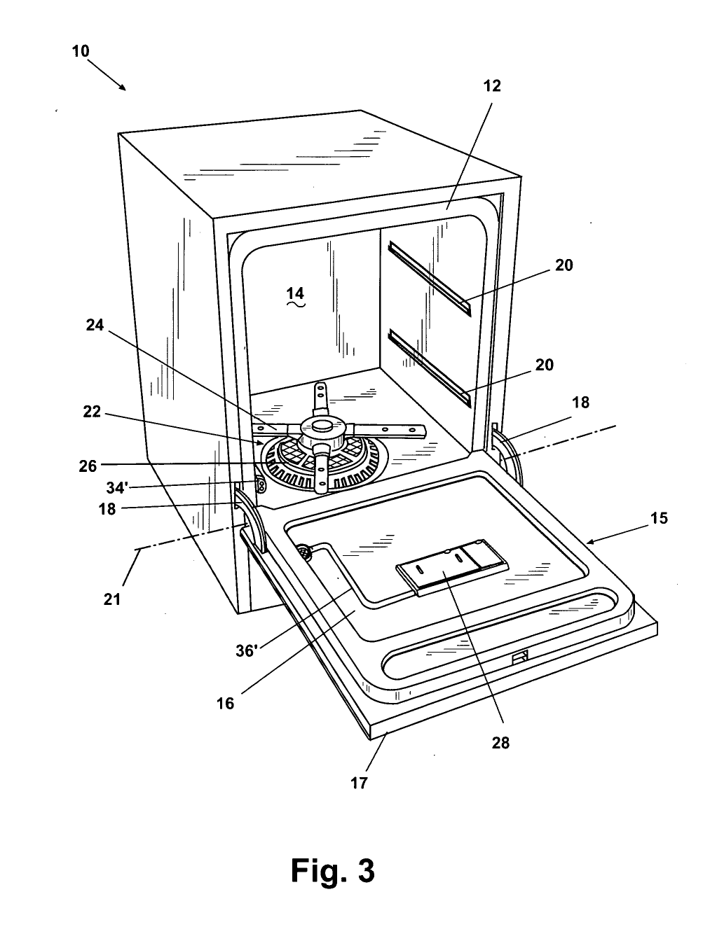

An alternative embodiment of the invention is depicted in FIGS. 3 and 4, where like objects are identified with like reference numerals. In this alternative embodiment, the transition portion is a fluid coupling 42 instead of a continuation of the hose as illustrated in the first embodiment. The alternative embodiment has a section of the first hose portion 34′ that is disposed in the wash chamber 14 and is carried by the interior of the housing 12. However, the first hose portion 34′ terminates at the housing/door interface with a tapered nose 46 forming a part of the fluid coupling 42. The second hose portion 36′ is mounted to the inner face 16 of the door 15 such that when the door 15 is in the closed position, the second hose portion 36 is disposed inside the wash chamber 14. The second hose portion 36′ terminates in a recess 47 that is complementary to the tapered nose 46 to form the other part of the fluid coupling 42. When the door 15 is closed, the nose 46 is received within the recess 47 to fluidly couple the hose portions 34′ and 36′. The interface between the nose 46 and recess 47 also forms a seal between the hose portions 34′ and 36′.

The openings of the first and second hose portions 34′, 36′ can be located anywhere along the interface between the wash chamber 14 and the door 15. However, the openings must be positioned at the same point along the interface; therefore, when the door is in the closed position, the openings of the first and second hose portions 34′, 36′ mate as described with the fluid coupling 42 therebetween. The benefit of the fluid coupling 42 is that the wherever the coupling 42 is located along the housing 12/door 15 interface, the coupling 42 does not interfere with the user access to the wash chamber 14 when the door 15 is open.

The invention is not limited to simple fluid couplings like the fluid coupling 42. More complex fluid couplings can be used if desired. For example, a more active or positive seal can be used, which could include O-rings or similar material coupling the hose portions 34′, 36′. Additionally, valves, such as check valves or selectively actuable valves such as solenoid valves, could be located in the hose portions 34′, 36′ near the nose 46 and recess 47 to prevent the spraying of liquid therefrom in response to the door being opened mid-cycle or during other times.

The section of the first hose portion 34′ mounted to the interior of the wash chamber 14 can optionally function as a rail for the dish basket 19, best seen in FIG. 4. When carried by the first hose portion 34′, the dish basket 19 can slide into and out of the wash chamber 14 in the same manner as when mounted on a conventional rail 20.

A primary difference between the liquid delivery system 30 of the second embodiment compared to that of the first embodiment is that the door 15 in the second embodiment must be in the closed position for the first hose portion 34′ to be in fluid communication with second hose portion 36′. In the first embodiment, the hose portions 34′, 36′ are in fluid communication regardless of the position of the door 15. However, this difference does not affect the operation of the invention because the door 15 must be in the closed position to operate the dishwasher 10. Therefore, the operation of the second embodiment is substantially identical to the operation of the first embodiment as described above.

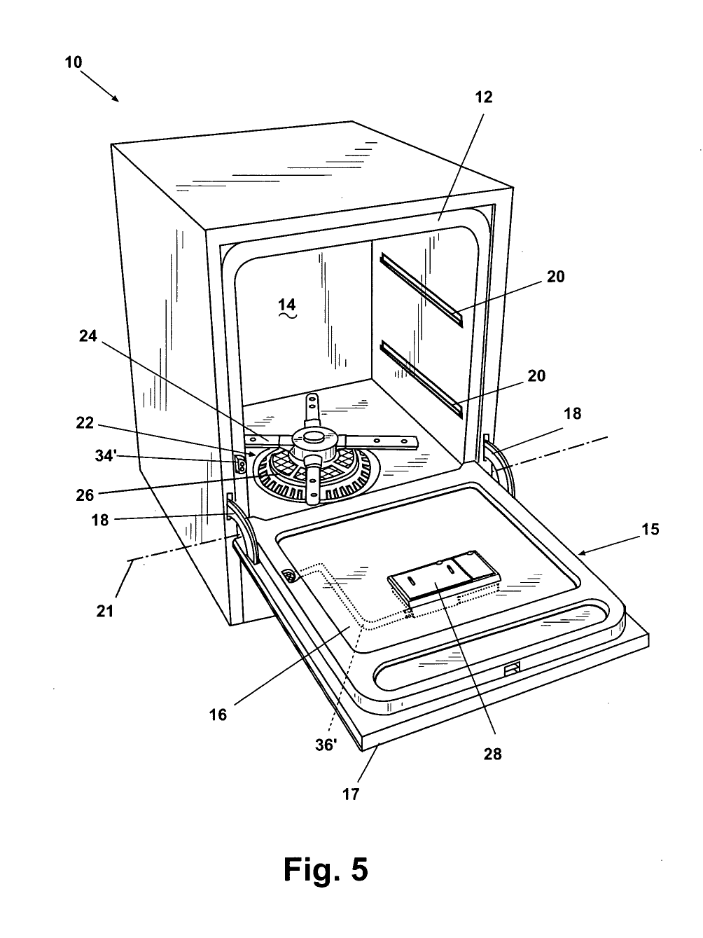

A third embodiment of the invention is depicted in FIG. 5, where like objects are identified with like reference numerals. This embodiment is identical to the second, except that the first hose portion 34″ is disposed in the housing 12 rather than being mounted to the side of the housing 12, and the second hose portion 36″ is located in the door 15 between the inner and outer faces 16, 17. Optionally, the bulk wash aid dispenser 28 can comprise a separate manifold and valve system 44 in the door 15 for receiving liquid from the second hose portion 36″ and distributing it to the bulk wash aid receptacles in the bulk wash aid dispenser 28. The operation of the third embodiment of the liquid delivery system 30 is identical to the operation of the second embodiment described above.

The invention provides a simple, efficient system for delivering liquid from an external supply or a wash chamber to a liquid-using accessory located on a dishwasher door. With the aid of the liquid delivery system, bulk wash aid dispensers, other types of wash aid dispensers, spray nozzles, and other accessories that require a supply of liquid other than the liquid that recirculates in the wash chamber, can be mounted in a convenient location on the inner face of the door. The system can be easily integrated into the structure of a conventional household dishwasher such that it is mostly, if not entirely, mounted in the interior of the dishwasher and, therefore, does not interfere with the aesthetic appearance of the appliance.

While the invention has been specifically described in connection with certain specific embodiments thereof, it is to be understood that this is by way of illustration and not of limitation, and the scope of the appended claims should be construed as broadly as the prior art will permit.

1. A household dishwasher, comprising:
a housing defining wash chamber in which dishes can be stored for washing and the wash chamber having a peripheral edge defining an open face providing access to the wash chamber;
a door having an inner face and movably mounted to the housing for movement between a closed position, where the door is adjacent the peripheral edge to close the open face to block access to the wash chamber, and an opened position, where the door is remote from the open face to permit access to the wash chamber;
a liquid sprayer for spraying liquid into the wash chamber and comprising a pump 10 and a spray arm fluidly connected to the pump such that the pump supplies liquid to the spray arm for spraying about the wash chamber;
a liquid-using washing accessory provided on the inner face of the door; and
a liquid delivery system for delivering liquid from at least one of an external supply and the wash chamber to the liquid-using washing accessory.

2. The household dishwasher according to claim 1, wherein the liquid delivery system comprises a liquid conduit comprising a first hose portion carried by the housing and fluidly coupled to one of the external supply and the wash chamber, a second hose portion carried by the door and fluidly coupled to the liquid-using washing accessory, and a transition portion fluidly coupling the first and second portions at an interface between the wash chamber and the door at least when the door is closed.

3. The household dishwasher according to claim 2, wherein the transition portion is a third hose portion fluidly connecting the first and second hose portions.

4. The household dishwasher according to claim 3, wherein at least one of the first, second, and third hose portions is extendable to accommodate any changes in the hose length needed to move the door between the opened and closed positions.

5. The household dishwasher according to claim 4, wherein at least the third hose portion is extendable.

6. The household dishwasher according to claim 3, wherein the first, second, and third hose portions are integrally formed to define a one-piece liquid conduit.

7. The household dishwasher according to claim 6, wherein the one-piece liquid conduit comprises multiple discrete fluid passages to provide multiple discrete sources of liquid to the liquid-using washing accessory.

8. The household dishwasher according to claim 7, wherein the second hose portion is located within the interior of the door.

9. The household dishwasher according to claim 3, wherein the door is hingedly mounted to the housing for rotation about a hinge axis and the third hose portion extends between the first and second hose portions at the portion of the interface coinciding with the hinge axis.

10. The household dishwasher according to claim 9, wherein the door is hingedly mounted to the housing at a lower portion of the housing and the hinge axis is generally horizontal so that the door will pivot between a generally vertical position when the door is in the closed position and a generally horizontal position when the door is open.

11. The household dishwasher according to claim 2, wherein the transition portion comprises a fluid coupling that fluidly couples the first and second hose portions when the door is in the closed position.

12. The household dishwasher according to claim 11, wherein the fluid coupling further comprises a valve to prevent the flow of water from the first hose portion to the second hose portion when the door is in the opened position.

13. The household dishwasher according to claim 12, wherein the fluid coupling further comprises a seal to fluidly seal the first and second hose portions when the door is in the closed position.

14. The household dishwasher according to claim 2, wherein the liquid delivery system further comprises a selectively-actuable, multiple outlet valve having one inlet connected to the external supply, one outlet connected to the wash chamber, and another outlet connected to the first hose portion to selectively control the supply of liquid from the external supply to either the wash chamber or first hose portion.

15. The household dishwasher according to claim 2, wherein the first and second hose portions comprise corresponding multiple liquid passageways and the liquid delivery system further comprises a selectively-actuable, multiple outlet valve having an inlet connected to the one of the external supply and the wash chamber, one outlet fluidly coupling one of the multiple passageways, and another outlet fluidly coupling another of the multiple passageways to selectively control the supply of liquid to the multiple passageways.

16. The household dishwasher according to claim 2, wherein the liquid-using wash accessory is a bulk wash aid dispenser.

17. A household dishwasher, comprising:
a housing defining a wash chamber in which dishes can be stored for washing and the wash chamber having a peripheral edge defining an open face providing access to the wash chamber;
a door having an inner face and movably mounted to the housing for movement between a closed position, where the door is adjacent the peripheral edge to close the open face to block access to the wash chamber, and an opened position, where the door is remote from the open face to permit access to the wash chamber;
a liquid sprayer for spraying liquid into the wash chamber and comprising a pump and a spray arm fluidly connected to the pump such that the pump supplies liquid to the spray arm for spraying about the wash chamber;
a bulk wash aid dispenser provided on the inner face of the door, and
a liquid delivery system for delivering liquid from at least one of an external supply and the wash chamber to the bulk wash aid dispenser.

18. The household dishwasher according to claim 17, wherein the liquid delivery system comprises:
a liquid conduit comprising a first hose portion carried by the housing and fluidly coupled to one of the external supply and the wash chamber,
a second hose portion carried by the door and fluidly coupled to the liquid-using washing accessory, and
a third hose portion fluidly coupling the first and second portions at an interface between the wash chamber and the door at least when the door is closed.

19. The household dishwasher according to claim 18, wherein the first, second, and third hose portions are integrally formed to define a one-piece liquid conduit.

20. The household dishwasher according to claim 19, wherein the one-piece liquid conduit comprises multiple discrete fluid passages to provide multiple discrete sources of liquid to the liquid-using washing accessory.

21. The household dishwasher according to claim 18, wherein at least one of the first, second, and third hose portions is extendable to accommodate any changes in the hose length needed to move the door between the opened and closed positions.

22. The household dishwasher according to claim 21, wherein the second hose portion is located within the interior of the door.

23. The household dishwasher according to claim 18, wherein the door is hingedly mounted to the housing for rotation about a hinge axis and the third hose portion extends between the first and second hose portions at the portion of the interface coinciding with the hinge axis.

25. The household dishwasher according to claim 24, wherein the door is hingedly mounted to the housing at a lower portion of the housing and the hinge axis is generally horizontal so that the door will pivot between a generally vertical position when the door is in the closed position and a generally horizontal position when the door is open.

26. The household dishwasher according to claim 18, wherein the liquid-using wash accessory is a bulk wash aid dispenser.
